(19) United States
(12) Patent Application Publication
(10) Pub. No.: US 2002/0126016 A1
(43) Pub. Date: Sep. 12, 2002

(54) Remotely controlled smoke alarm assembly

(76) Inventor: Corey Bouche?apos; Sipp, Warner Robins, GA (US)

Correspondence Address: Corey B. Sipp, 144 Stoneridge Dr., Warner Robins, GA, 31088, US

(21) Appl. No.: 09/800,176

(22) Filed: Mar. 6, 2001

(51) Int. Cl. G08B 17/10

(52) U.S. Cl. 340/628; 340/632

(57) ABSTRACT

A remotely controlled smoke detector system includes a plurality of smoke detectors, each selectively controllable with a remote control unit. The remote control unit can adjust the sensitivity of a selected smoke detector or alternatively can disable a select detector for a desired duration. The selected sensitivity is displayed on an LED disposed on both the remote unit and each smoke detector.

### BACKGROUND OF THE INVENTION

The present invention relates to a smoke alarm assembly in which the operating duration and sensitivity of a plurality of smoke detectors may be selectively varied with a remote control device.

### DESCRIPTION OF THE PRIOR ART

Various remotely controlled smoke alarms exist in the prior art. For example, U.S. Pat. No. 4,600,314 issued to Theriault discloses a smoke detector cutoff timer having a control knob for setting a predetermined delay time using a control box mounted to the wall.

U.S. Pat. No. 4,788,530 issued to Bernier discloses a control box mounted to the wall which can allow the alarm to be temporarily disconnected in the event of a false alarm.

U.S. Pat. No. 4,363,031 issued to Reinowitz discloses a wireless alarm system.

U.S. Pat. No. 5,442,336 issued to Murphy et al relates to a remote system for disabling a smoke detector for a predetermined period of time. The remote device controls one of several smoke detectors upon a user entering a code. A smoke alarm may then be remotely triggered or deactivated for a predetermined period of time.

U.S. Pat. No. 5,422,629 issued to Minnis discloses a photoelectric system for reducing the sensitivity of a fire alarm.

U.S. Pat. No. 5,093,651 issued to Thomas discloses a timing circuit interconnected between the battery and the detector portion of the smoke detector allowing the detector to be manually deactivated for a short period of time.

### SUMMARY OF THE INVENTION

The present invention relates to a remotely controlled smoke detector system including a remote unit which may separately control a plurality of smoke detectors. The remote unit includes a plurality of selector buttons each corresponding to a select smoke detector which enables the remote to be in selective communication therewith. The remote further includes a disable button and a plurality of reset buttons, each for reactivating the select detector after a predetermined period of time. The remote unit also includes a sensitivity adjustment means for adjusting the sensitivity of a select detector. It is therefore an object of the present invention to provide a smoke detector assembly in which a plurality of smoke detectors may be controlled with a single remote.

It is yet another object of the present invention to provide a smoke detector assembly in which any one of a plurality of smoke detectors may be selectively deactivated for desired durations. Other objects, features, and advantages of the present invention will become readily apparent from the following detailed description of the preferred embodiment when considered with the attached drawings and the appended claims.

### BRIEF DESCRIPTION OF THE DRAWINGS

FIG. 1 is a schematic of the smoke detector circuitry according to the present invention.

FIG. 2 is a flow chart of the smoke detector circuitry.

FIG. 3 is a schematic of the remote control circuitry.

FIG. 4 is a flow chart of the remote control circuitry.

FIG. 5 depicts the remote unit.

FIG. 6 depicts the smoke detector.

### DESCRIPTION OF THE PREFERRED EMBODIMENT

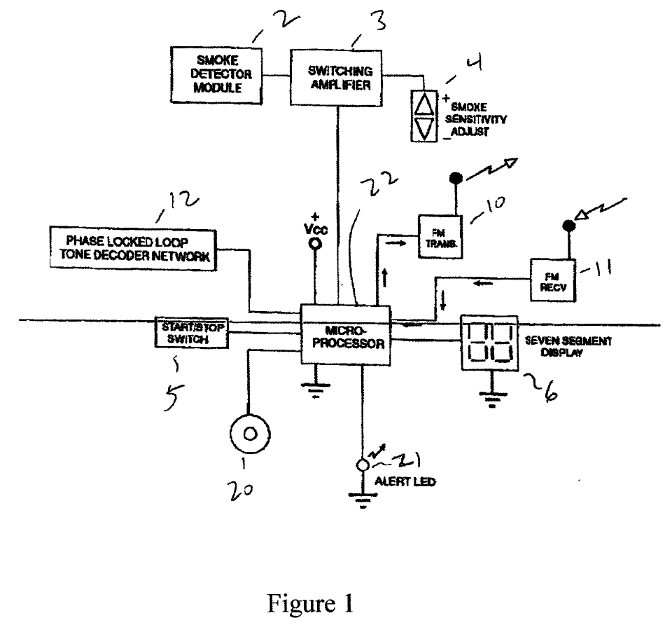

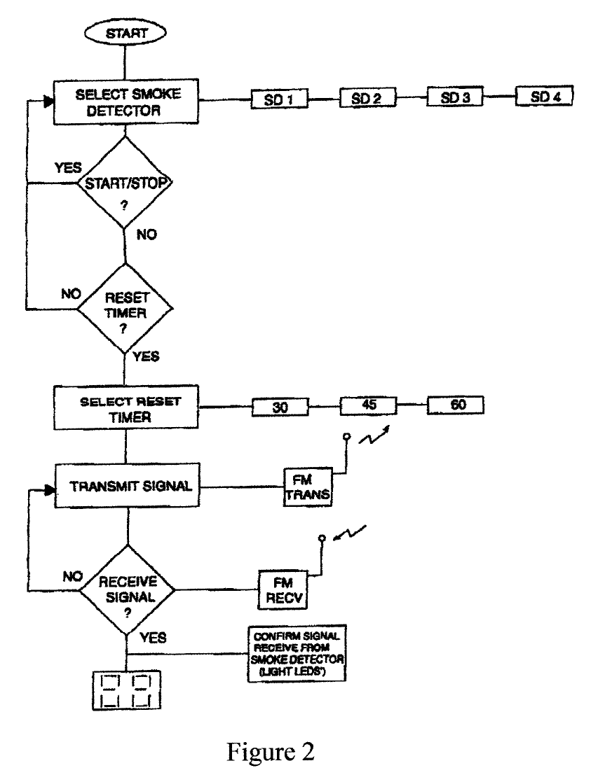

Referring now to FIGS. 1, 2 and 6, the present invention relates to a remotely controlled smoke detector system including a plurality of smoke detectors 1. Each smoke detector includes an on/off switch 5 for enabling a conventional smoke detector module 2 in communication with a microprocessor 22. The microprocessor activates an audible alarm 20 and an LED 21 upon the module sensing a predetermined concentration of smoke. The microprocessor is in communication with a switching amplifier 3 as well as a sensitivity adjustment means 4 that adjusts the bias voltage of the switching amplifier circuit. The sensitivity adjustment means, via the microprocessor, also manipulates a seven segment display means 6 on the exterior of each smoke detector for digitally displaying the selected sensitivity. The microprocessor is in communication with an FM transmitter 10 and receiver 11 for transmitting and receiving signals from a remote unit 23. A phase locked loop tone decoder network 12 is also controlled by the microprocessor 22 which allows each smoke detector to respond only to a select square wave frequency transmitted by the remote unit.

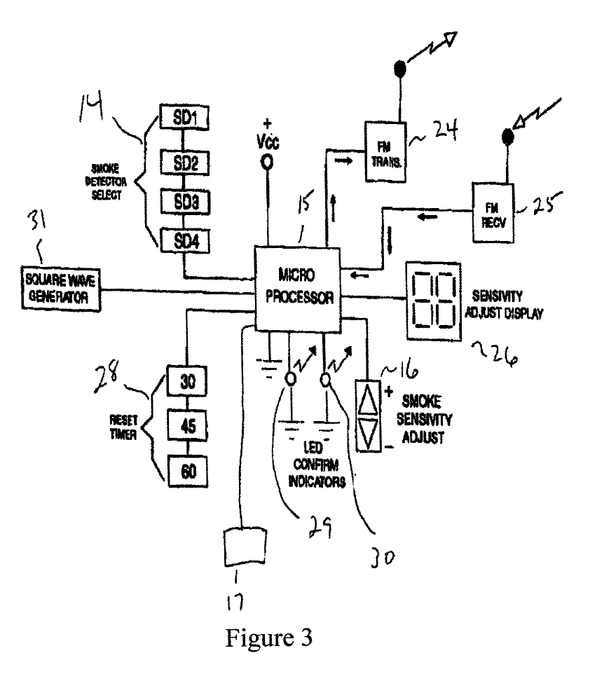

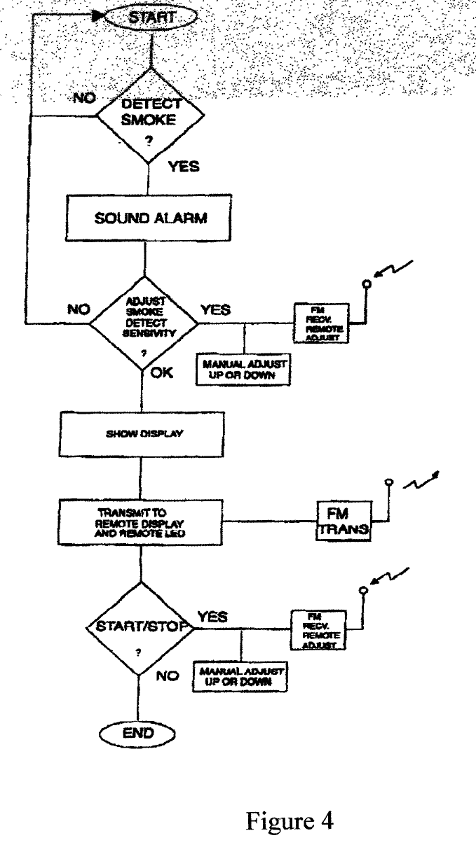

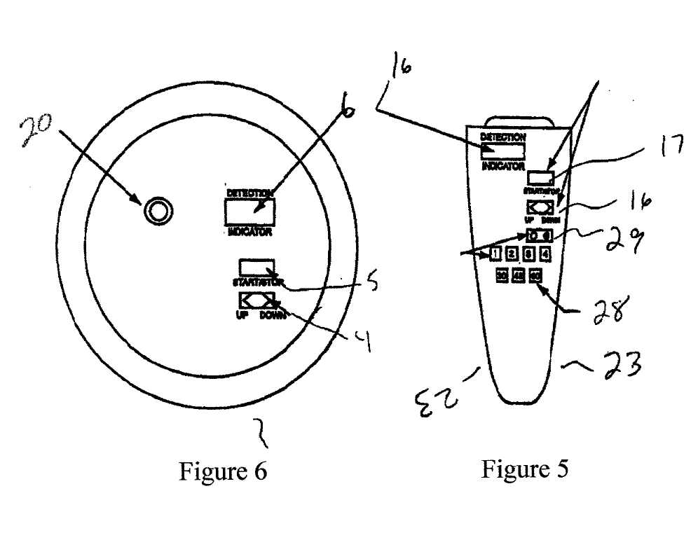

Referring now to FIGS. 3-5, the remote unit 23 includes a plurality of selector buttons 14 thereon, each corresponding to a designated smoke detector. The remote also includes a microprocessor 15 and a square wave tone generator 31 that transmits a discrete square wave frequency for each selector button that is depressed. Accordingly, the remote unit can selectively control any one of a plurality of smoke detectors by depressing the selector button corresponding thereto. The microprocessor receives and transmits information to and from the selected detector via a transmitter 24 and receiver 25. The remote also includes a sensitivity adjustment means 16 and a sensitivity display 26 in communication with the microprocessor. An on/off switch 17 remotely disables a select detector. A plurality of reset buttons 28 each corresponding to a select duration (i.e. 30, 45 and 60 minutes, for example) are in communication with the microprocessor. Depressing one of the reset buttons immediately after disabling a detector will automatically reactivate the detector upon the expiration of the predetermined duration. The remote also includes a pair of LED's, one 29 of which confirms that the selected detector has been successfully programmed while the other 30 is illuminated if communication with the detector fails.

To use the above described assembly, a user selects an individual detector by depressing the corresponding selector button on the remote unit. The user may then disable the selected detector or adjust the sensitivity thereof The local microprocessor within the smoke detector, via the transmitter 10 transmits a signal back to the remote unit that displays the selected sensitivity on the remote display and illuminates the corresponding LED. If the selected smoke detector has been deactivated and a user wishes to reactivate the smoke detector within a predetermined time period, one of the reset buttons corresponding to the desired time period is also depressed. Upon the expiration of the predetermined time period, the smoke detector will be reactivated.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims.

1. What I claim as my invention is a smoke alarm assembly in which the operating duration and sensitivity of a plurality of smoke detectors may be selectively varied with a remote control device.
